(19) United States
(12) Patent Application Publication
(10) Pub. No.: US 2019/0377604 A1
(43) Pub. Date: Dec. 12, 2019

(54) SCALABLE FUNCTION AS A SERVICE PLATFORM

(71) Applicant: Nuweba Labs Ltd., Tel Aviv-Jaffa (IL)

(72) Inventor: Yan CYBULSKI, Tel-Aviv (IL)

(73) Assignee: Nuweba Labs Ltd., Tel Aviv-Jaffa (IL)

(21) Appl. No.: 16/437,363

(22) Filed: Jun. 11, 2019

Related U.S. Application Data
(60) Provisional application No. 62/683,196, filed on Jun. 11, 2018.

(51) Int. Cl. G06F 9/50; G06F 9/48

(52) U.S. Cl. CPC G06F 9/505; G06F 9/4881; G06F 9/5044

(57) ABSTRACT

A scalable platform for providing functions as a service (FaaS). Software container pods are defined. Each pod is a software container including code for a respective function that acts as a template for that function. When a function is called, a new instance of a corresponding pod is added if no pods are available. Instances of the same pod may share memory until one of the instances is modified. Calling of functions may be delayed depending on a type of event involving the function.

### CROSS-REFERENCE TO RELATED APPLICATIONS

This application claims the benefit of U.S. Provisional Application No. 62/683,196 filed on Jun. 11, 2018, the contents of which are hereby incorporated by reference.

### TECHNICAL FIELD

The present disclosure relates generally to cloud computing services, and more specifically to function as a service (FaaS).

### BACKGROUND

Organizations have increasingly adapted their applications to be run from multiple cloud computing platforms. Some leading public cloud service providers include Amazon®, Microsoft®, Google®, and the like. Serverless computing platforms provide a cloud computing execution model in which the cloud provider dynamically manages the allocation of machine resources. Such platforms, also referred to as function as a service (FaaS) platforms, allow execution of application logic without requiring storing data on the client's servers. Commercially available platforms include AWS Lambda by Amazon®, Azure® Functions by Microsoft®, Google Cloud Functions Cloud Platform by Google®, OpenWhisk by IBM®, and the like.

“Serverless computing” is a misnomer, as servers are still employed. The name “serverless computing” is used to indicate that the server management and capacity planning decisions of serverless computing functions are not managed by the developer or operator. Serverless code can be used in conjunction with code deployed in traditional styles, such as microservices. Alternatively, applications can be written to be purely serverless and to use no provisioned services at all.

Further, FaaS platforms do not require coding to a specific framework or library. FaaS functions are regular functions with respect to programming language and environment. Typically, functions in FaaS platforms are triggered by event types defined by the cloud provider. Functions can also be trigged by manually configured events or when a function calls another function. For example, in Amazon® AWS®, such triggers include file (e.g., S3) updates, passage of time (e.g., scheduled tasks), and messages added to a message bus. A programmer of the function would typically have to provide parameters specific to the event source it is tied to.

A serverless function is typically programmed and deployed using command line interface (CLI) tools, an example of which is a serverless framework. In most cases, the deployment is automatic and the function's code is uploaded to the FaaS platform. A serverless function can be written in different programming languages, such as JavaScript®, Python®, Java®, and the like. A function typically includes a handler (e.g., handler.js) and third-party libraries accessed by the code of the function. A serverless function also requires a framework file as part of its configuration. Such a file (e.g., serverless.yml) defines at least one event that triggers the function and resources to be utilized, deployed or accessed by the function (e.g., database).

Some serverless platform developers have sought to take advantage of the benefits of software containers. For example, one of the main advantages of using software containers is the relatively fast load times as compared to virtual machines. However, while load times such as 100 ms may be fast as compared to VMs, such load times are still extremely slow for the demands of FaaS infrastructures.

Other challenges to using software containers in FaaS platforms are bottlenecks and, in particular, bottlenecks associated with provisioning resources to accommodate new requests. For FaaS services using containers to provide functions, a major performance bottleneck occurs when new containers are initiated. These bottlenecks effectively prevent scaling beyond a certain frequency of requests for functions. Thus, FaaS platforms using containers face challenges in scalability to meet demand.

Another challenge faced by FaaS platforms include degradations in performance due to load imbalances among containers and high memory use by the various containers. Some solutions for these challenges exist, but such existing solutions usually involve increasing the footprint (i.e., the amount of additional systems and/or processes) on the infrastructure. This, in turn, increases the complexity of the platform and, therefore, increases required hardware and maintenance.

FIG. 1 shows an example diagram 100 illustrating an existing FaaS platform 110 providing functions for various services 120-1 through 120-6 (hereinafter referred to as services 120 for simplicity). Each of the services 120 may utilize one or more of the functions provided by the respective software containers 115-1 through 115-4 (hereinafter referred to as a software container 115 or software containers 115 for simplicity). Each software container 115 is configured to receive requests from the services 120 and provides functions in response.

To this end, each software container 115 includes code of the respective function. When multiple requests for the same software container 115 are received around the same time, a performance bottleneck occurs. Adding more containers can allow for better performance in providing the respective functions, but significantly increases the amount of total memory required, because each container 115 would require its own portion of memory (not shown). Further, adding more containers 115, on demand, results in the above-noted performance bottlenecks related to instantiating new containers.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein includes a scalable platform for providing functions as a service (FaaS) comprising: at least one master node executed over a hardware layer; a plurality of worker nodes communicatively connected to the at least one master node and independently executed over a hardware layer; wherein each of the plurality of worker nodes includes at least one pod, wherein each pod is a software container including code for executing a respective serverless function; and wherein the at least one pod of each of the plurality of operational nodes is scalable on demand by the at least one master node.

Certain embodiments disclosed herein includes a method for migrating serverless functions from a first functions as a service (FaaS) platform to a second FaaS platform. The method comprises obtaining code and configurations of a plurality of serverless functions from the first FaaS platform; updating an infrastructure of the second FaaS platform by deploying software images of the plurality of serverless functions, wherein the second FaaS platform is a scalable FaaS platform; obtaining, from the first FaaS platform, a current load for each of the plurality of serverless functions; and scaling the second FaaS platform based on the obtained current loads.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a diagram illustrating a function as a service (FaaS) platform providing functions for various services.

FIGS. 2A, 2B and 2C are diagrams illustrating a scalable FaaS platform providing functions for various services utilized to describe various disclosed embodiments.

FIG. 3 is a flowchart illustrating the migration of functions to a scalable FaaS platform according to an embodiment.

FIG. 4 is a flowchart illustrating a method for scalable deployment of software containers in a FaaS platform according to an embodiment.

FIG. 5 is a schematic diagram of a hardware layer according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a scalable platform for providing functions as a service (FaaS). Software container pods are utilized according to the disclosed embodiments. Each pod is a software container including code for a respective serverless function that acts as a template for each pod associated with that serverless function. When a function is called, it is checked if a pod containing code for the function is available. If no appropriate pod is available, a new instance of the pod is added to allow the shortest possible response time for providing the function. In some configurations, when an active function is migrated to a new FaaS platform, a number of initial pods are re-instantiated on the new platform.

In an embodiment, each request for a function passes to a dedicated pod for the associated function. In some embodiments, each pod only handles one request at a time such that the number of concurrent requests for a function that are being served are equal to the number of running pods. Instances of the same pod may share a common physical memory or a portion of memory, thereby reducing total memory usage.

The pods may be executed in different environments, thereby allowing different types of functions in a FaaS platform to be provided. For example, Amazon® Web Services (AWS) Lambda functions, Azure® functions, and IBM® Cloud functions may be provided using the pods deployed in a FaaS platform as described herein. The functions are services for one or more containerized application platform (e.g., Kubernetes®). A function may trigger other functions.

In an embodiment, the platform includes an autoscaler configured to receive events representing requests (e.g., from a kernel, for example a Linux kernel, of an operating system) and to scale the pod services according to demand. To this end, the autoscaler is configured to increase the number of pods as needed and that are available on-demand, while ensuring low latency. For example, when a request for a function that does not have an available pod is received, the autoscaler increases the number of pods. Thus, the autoscaler allows for scaling the platform per request.

The events received by the autoscaler may include, but are not limited to, synchronized events, asynchronized events, and polled events. The synchronized events may be passed directly to the pods to invoke their respective functions. The asynchronized events may be queued before invoking the respective functions.

The disclosed scalable FaaS platform further provides an ephemeral execution environment for each invocation of a serverless function. This ensures that each function's invocation is executed to a clean environment, i.e., without any changes that can occur after beginning execution of the code that can cause unexpected bugs or problems. Further, an ephemeral execution environment is secured to prevent persistency in case an attacker successfully gains access to a function environment.

To provide an ephemeral execution environment, the disclosed scalable FaaS platform is configured to prevent any reuse of a container. To this end, the execution environment of a software container (within a pod) is completely destroyed at the end of the invocation and each new request is served by a new execution environment. This is enabled by keeping pods warm for a predefined period of time through which new requests are expected to be received.

In an embodiment, the disclosed scalable FaaS platform is configured to handle three different types of events that trigger execution of serverless functions. Such types of events include synchronized events, asynchronized events, and polled events. The synchronized events are passed directly to a cloud service to invoke the function in order to minimize latency. The asynchronized events are first queued before invoking a function. The polled events cause an operational node (discussed below) to perform a time loop that will check against a cloud provider service, and if there are any changes in the cloud service, a function is invoked.

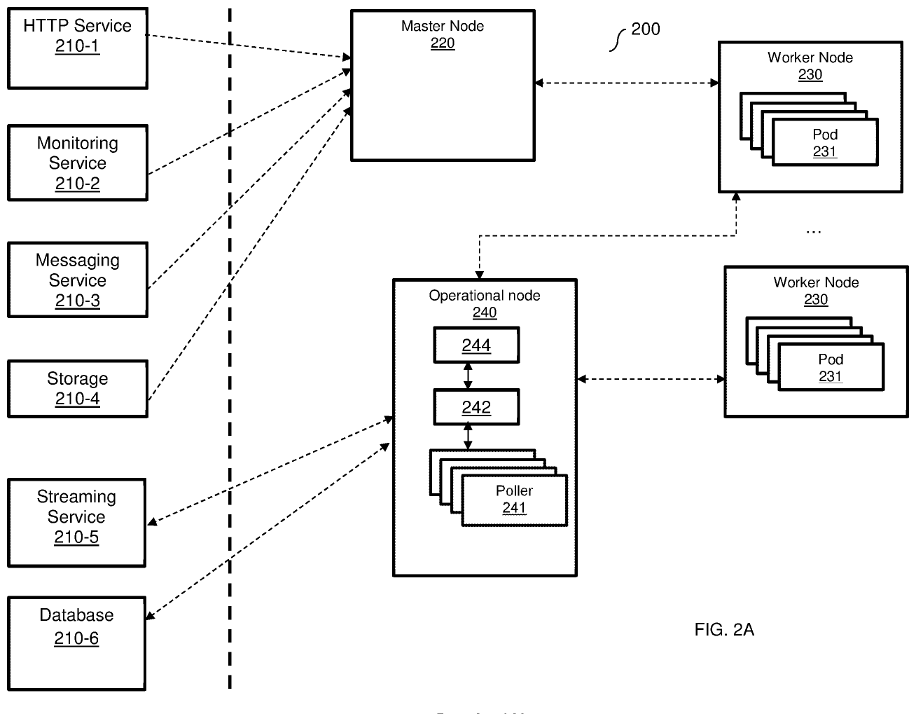

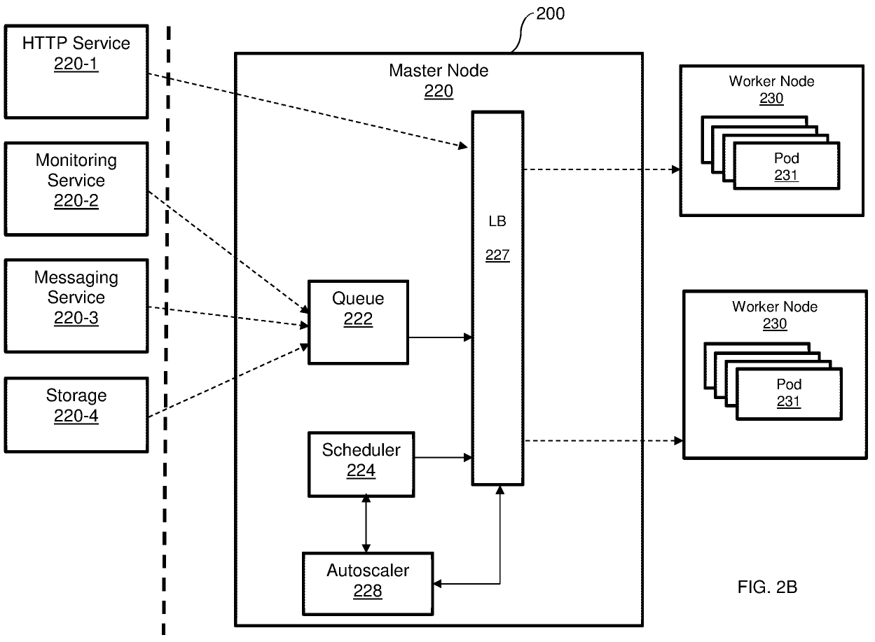

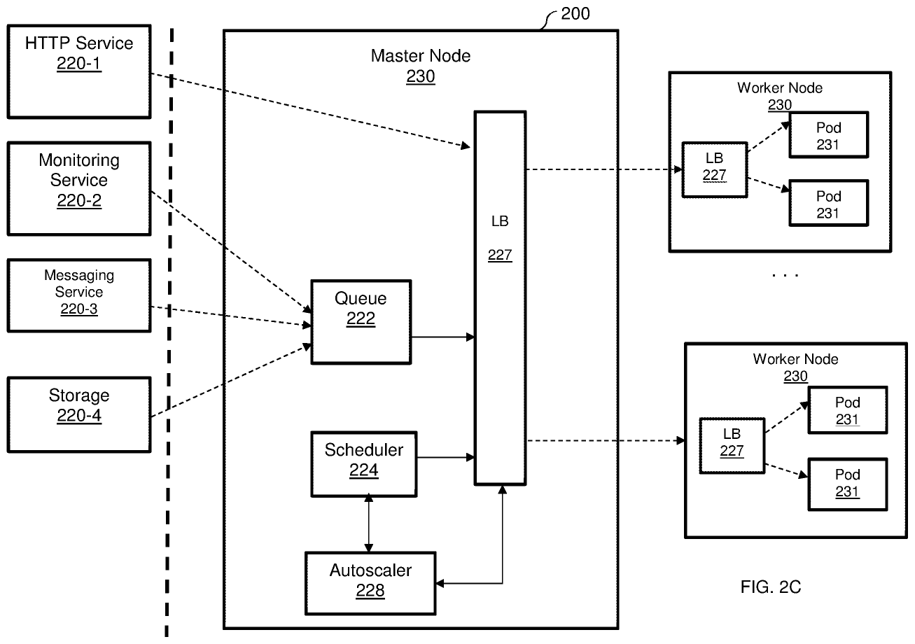

FIG. 2A is an example diagram of a scalable FaaS platform 200 according to an embodiment. In this example embodiment, the FaaS platform 200 provides serverless functions to services 210-1 through 210-6 (hereinafter referred to individually as a service 210 or collectively as services 210 for simplicity) through the various nodes. In an embodiment, there are three different types of nodes: master node 220, worker node 230, and operational node 240. In an embodiment, the scalable FaaS platform 200 includes a master node 220, one or more worker nodes 230, and one or more operational nodes 240.

The master node 220 is configured to orchestrate the operation of the worker nodes 230 and an operational node 240. An example arrangement of the master node 220 is provided in FIGS. 2B and 2C. A worker node 230 includes pods 231 configured to execute serverless functions. Each such pod 231 is a software container configured to perform a respective function such that, for example, any instance of the pod 231 contains code for the same function. The operational nodes 240 are utilized to run functions for streaming and database services 210-5 and 210-6. The operational nodes 240 are further configured to collect logs and data from worker nodes 230.

In an embodiment, each operational node 240 includes one or more pollers 241, an event bus 242 and a log aggregator 244. A poller 241 is configured to delay provisioning of polled events indicating requests for functions. To this end, a poller 241 is configured to perform a time loop and to periodically check an external system (e.g., a system hosting one or more of the services 210) for changes in state of a resource, e.g., a change in a database entry. When a change in state has occurred, the poller 241 is configured to invoke the function of the respective pod 231.

The event bus 242 is configured to allow communication between the other nodes and the other elements (e.g., the poller 241, log aggregator 244, or both) of the operational node 240. The log aggregator 244 is configured to collect logs and other reports from the worker nodes 230.

In an example implementation, the poller 241 may check the streaming service 210-5 and the database 210-6 for changes in state and, when a change in the state of one of the services 210-5 or 210-6 has occurred, to invoke the function requested by the respective service 210-5 or 210-6.

In an embodiment, the master node 220 further includes a queue, a scheduler, a load balancer, and an autoscaler (not shown in FIG. 2A) utilized during the scheduling of functions. Scheduling execution of functions by the nodes 230 and 240 can be performed using a centralized or distributed scheduling method, for example as discussed in greater detail with reference to FIGS. 2B and 2C, respectively.

It should be noted that, in a typical configuration, there are a small number of master nodes 230 (e.g., 1, 3, or 5 master nodes), and a larger number of worker nodes 230 and operational nodes 240 (e.g., millions). The worker nodes 230 and operational nodes 240 are scaled on demand.

In an embodiment, the nodes 220, 230, and 240 may provide a different FaaS environment, thereby allowing for FaaS functions, for example, of different types and formats (e.g., AWS® Lambda, Azure®, and IBM® functions). The communication among the nodes 220 through 240 and between the nodes 220 through 240 and the services 210 may be performed over a network, e.g., the Internet (not shown).

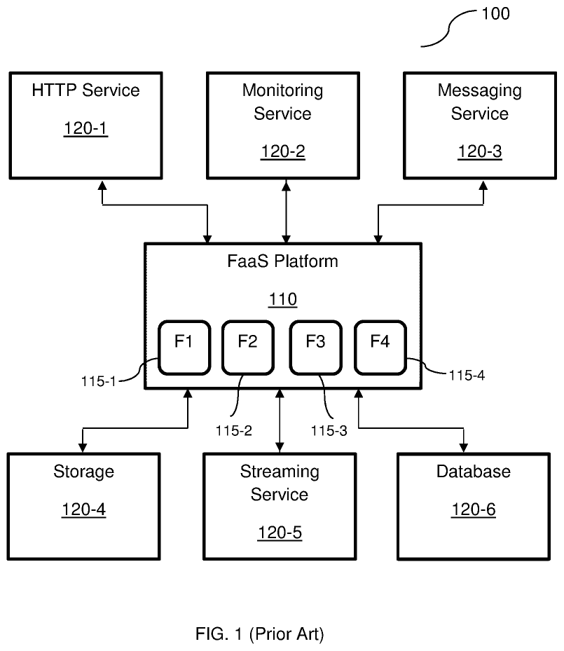

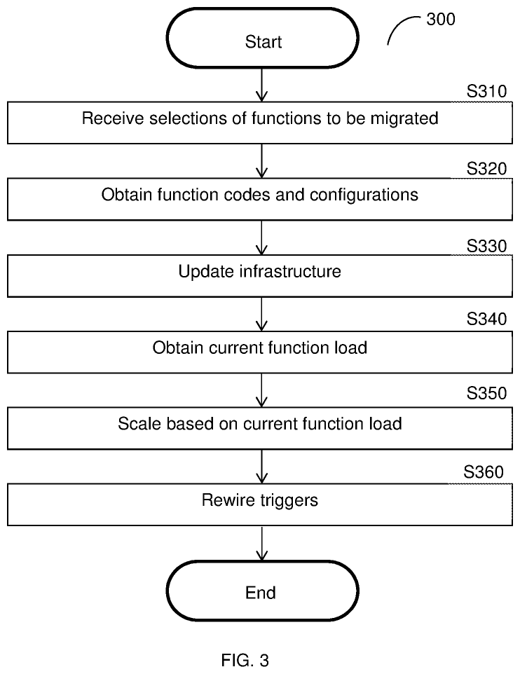

In some implementations, the FaaS platform 200 may allow for seamless migration of functions used by existing customer platforms (e.g., the FaaS platform 110, FIG. 1). The seamless migration may include moving code and configurations to the FaaS platform 200. The FaaS platform 200 may be scaled based on the existing load on the migrated functions (e.g., the functions 115, FIG. 1), and the services (e.g., the services 120, FIG. 1) utilizing the functions may be rewired to the FaaS platform 200. Further, the seamless migration may be a “one click” migration in which, from the perspective of a developer or operator of the original FaaS platform, selected functions are migrated by a single click. An example method for migrating functions to a scalable FaaS platform is described further below with respect to FIG. 3.

It should be noted that the services 210 are merely examples and that more, fewer, or other services may be provided with functions by the FaaS platform 200 according to the disclosed embodiments. The services 210 may be hosted in an external platform (e.g., a platform of a cloud service provider utilizing the provided functions in its services). Requests from the services 210 may be delivered via one or more networks (not shown). It should also be noted that the numbers and arrangements of the nodes 220, 230, and 240 and their respective pods are merely illustrative, and that other numbers and arrangements may be equally utilized. In particular, the number of pods may be dynamically changed as discussed herein to allow for scalable provisions of functions.

FIG. 2B is an example diagram of the FaaS platform 200 utilized to describe a centralized scheduling execution of functions according to an embodiment. As detailed in FIG. 2B, the master node 220 includes a queue 222, a scheduler 224, a load balancer (LB) 227, and an autoscaler 228. In an example embodiment, a load balancer 227 can be realized as an Internet Protocol Virtual Server (IPVS). The load balancer 227 acts as a load balancer for the pods 231 (in the worker nodes 230) and is configured to allow at most one connection at a time, thereby ensuring that each pod 231 only handles one request at a time. In an embodiment, a pod 231 is available when a number of connections to the pod is zero.

In one embodiment, the load balancer 227 is configured to receive requests to run functions by the pods 231 and balance the load among the various pods 231. When such a request is received, the load balancer 227 is first configured to determine if there is an available pod. If so, the request is sent to the available pod at a worker node 230. If no pod is available, the load balancer 227 is configured to send a scan request to the autoscaler 228. The autoscaler 228 is further configured to determine a number of pods that would be required to process the function. The required number of pods are reported to the scheduler 224, which activates one or more pods on the worker node(s) 230. That is, the scheduler 224 is configured to schedule activation of pod based on demand. An activated pod (e.g., pod 231-2) reports its identifier, IP address, or both, to the load balancer 227. The load balancer 227 registers the activated pod and sends the received request to the newly activated pod.

In another configuration, such as the architecture demonstrated in FIG. 2C, each worker node 230 is configured with its own load balancer 227. Providing each node 230 with its own load balancer 227 allows for minimizing latency as well as the footprint on the FaaS platform 200. This, in turn, enhances scalability functions. In this configuration, each worker node 230 may be configured to reduce costs with respect to, for example, memory and CPU consumption.

In an embodiment, when a load balancer 227, is configured to receive a request to run a serverless function and there is no available pod, the load balancer 227 is configured to request the scheduler 224 to select one of the worker nodes 230 to serve the request. In an example embodiment, the selection of the node may be based on the load of each worker node. To this end, the load balancer 227 is configured to collocate, using the operational nodes, load information related to at least CPU and memory utilization of each node.

The request is then sent to the selected worker node over a certain port that is associated with the function to run. Then, a load balancer 227 on the selected worker node activates one of its pods based on the port number on which the request was received. The selected worker node does not inform the other nodes about the identifier of the pod being activated.

In another embodiment, a distributed load balancing is performed. In this embodiment, a request to run a serverless function is received by the load balancer 227 which broadcasts the received request to all worker nodes 230. All worker nodes receiving the request competes on serving the request. Specifically, each worker node returns a score indicating how well it can serve the request. The request is sent to the first worker node whom responded with a score higher than a predefined threshold. For example, if the score is an integer number between 1 and 10, then the node with the highest score is selected.

In an embodiment, if no node responds with a score or if the score is below a predefined threshold, the master node 230 requests the autoscaler 228 to instantiate a new worker node. The request is sent to the new worker node. It should be noted that the same process is applicable to operational nodes 240 when processing requests from streaming and database services.

Returning to FIG. 2A, according to some embodiments, in order to optimize the load time for new containers, each pod 231 of the same function is generated from a template that is stateless and identical to other pods 231 of the same function until processing of a request begins. When processing of the request begins, the generated pod 231 is initialized, booted, running, and suspended in a portion of memory (not shown) of the respective worker node 230. It should be noted that the templates are not processed. To this end, an operating system inside each active pod 231 is running and the runtime environment for the pod 231 is loaded. Depending on the environment, the code of the pod 231 may be parsed and ready for execution.

In an embodiment, when the number of available pods 231 contains a code to perform a requested function is zero, the queue 222 is configured to queue such connections until new pods 231 are added or existing pods 231 become available, for example whichever occurs first. In the example diagram 200, the queue 222 queues requests for functions from each of the pods 231 when such requests are received around the same time (i.e., such that one or more requests are received while another request for the same function is being served) from multiple services 220-2 through 220-4.

The autoscaler 228 is configured to receive events indicating pending requests (e.g., from a kernel, for example a Linux® kernel, of an operating system) and to scale the pods 231 according to demand. To this end, the autoscaler 228 is configured to increase the number of pods 231 as needed (e.g., when a request for a function that does not have an available pod 231 is received). The autoscaler 228 may have access to the queue 222 having pending connections as well as load balancer service availability event messages to allow for determining required scaling in real-time as requests are received. Using this information, the autoscaler 228 may determine which functions are being requested and whether new instances of respective pods 231 need to be added to serve the pending requests.

In some implementations, the autoscaler 228 may be configured to determine an anticipated need (e.g., a maximum expected number of queued requests for the function) for each function and to implement predictive scaling based on the anticipated need. The predictive scaling may be based on historical queues, availability events, or both. The autoscaler 228 may be further configured to determine when there are extraneous pods 231 (i.e., when more pods 231 are available for a function then it would be required for pending or anticipated requests), and to scale down by removing some of the instances of the extraneous pods 231.

In an embodiment, the events received by the autoscaler 228 include synchronized events, asynchronized events, and polled events. The autoscaler 228 is configured to pass synchronized events directly to the respective pods 231 to invoke their respective functions. The autoscaler 228 is further configured to direct asynchronized events to the queue 222 to be queued before invoking the respective functions.

In some embodiments, the autoscaler 228 is configured to send polled events to the poller 241 to be delayed until a change in state of an external system (e.g., a system hosting one or more of the services 210). It should be noted that events are also sent to processing even if they are queued.

In an embodiment, when a new instance of a pod is created, the new pod loads the process from memory. The memory used by a pod is not cloned when the pod is forked. To this end, each function may have a portion of memory associated with such that, when a new instance of a pod invoking the function is added, the instance of the pod is mapped to the portion of memory associated with the respective function rather than assigning a new portion of memory to the new instance. In a further embodiment, when a change is made to one of the instances of the pod, the respective portion of memory is copied and changed accordingly. Sharing memories among instances of the same pod allows for reducing total memory usage among pods executing the same function.

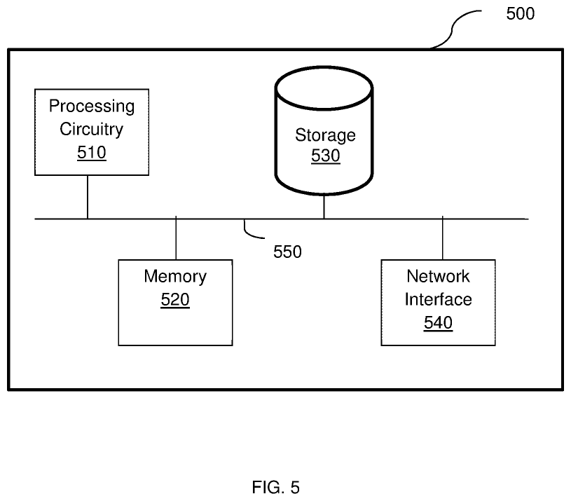

It should also be noted that the flows of requests shown in FIGS. 2A and 2B (as indicated by dashed lines with arrows in FIGS. 2A and 2B) are merely examples used to demonstrate various disclosed embodiments and that such flows do not limit the disclosed embodiments. It should be further noted each of the nodes, 220, 230, and 240 requires an underlying hardware layer (not shown in FIGS. 2A, 2B, and 2C) to execute the operating system, the pods, load balancers, and other functions of the master node. An example block diagram of a hardware layer is provided in FIG. 5. Furthermore, the various elements of the nodes 220 and 240 (e.g., the scheduler, autoscaler, pollers, event bus, log aggregator, etc.) can be realized as pods. As noted above, a pod is a software container. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). Such Instructions are executed by the hardware layer.

It should be understood that the embodiments described herein are not limited to the specific architecture illustrated in FIGS. 2A, 2B and 2C, and other architectures may be equally used without departing from the scope of the disclosed embodiments.

FIG. 3 is an example flowchart 300 illustrating a method for migrating functions to a scalable FaaS platform according to an embodiment. In an example implementation, the migrated functions may be the functions of a first FaaS platform (e.g., the functions 115 of the FaaS platform 110, FIG. 1), which are migrated to a second scalable FaaS platform (e.g., the FaaS platform 210, FIG. 2).

At optional S310, selections of functions to be migrated from the first FaaS platform to the second FaaS platform are received. The selections may be received via a user interface (e.g., a dashboard) presented to a user of a cloud service provider system. Alternatively, all functions or predetermined functions may be selected automatically.

At S320, function codes and configurations for the selected functions are obtained. The function code and configurations may be retrieved from software containers configured to execute the functions in the first FaaS platform.

At S330, the infrastructure of the second FaaS platform is updated. In an embodiment, updating the infrastructure includes creating and deploying one or more new software images based on the obtained function codes and configurations.

At S340, a current function load for each function is obtained from the first FaaS platform.

At S350, based on the obtained current function loads, the second FaaS platform is scaled accordingly. In an embodiment, scaling the platform includes adding new instances of software containers (e.g., the pods 231, FIG. 2) as described further herein above. Specifically, each added instance is a new instance of a pod, which is a generic template software container including code for executing a particular function. In a further embodiment, a portion of memory is assigned for each pod, with different instances of the pod sharing the portion of memory until one of the instances is changed.

At S360, triggers for the functions are rewired from being directed to the first FaaS platform to the second FaaS platform. Thus, subsequent requests for the functions are directed to the second FaaS platform.

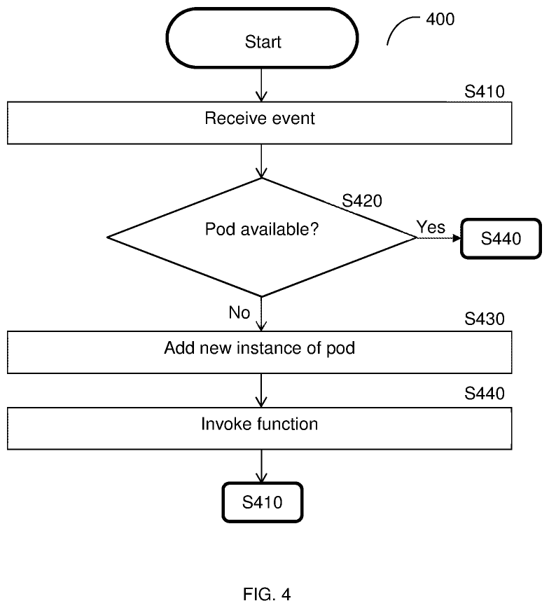

FIG. 4 is an example flowchart 400 illustrating a method for scalable deployment of software containers in a FaaS platform according to an embodiment. In an embodiment, the method is performed by the autoscaler 228.

At S410, an event indicating a request for running a function is received. The request is for a function whose code is included in a pod of a scalable FaaS platform (e.g., the scalable FaaS platform 200, FIG. 2). The event may be a synchronized event, an asynchronized event, or a polled event, as described herein above. In some implementations, the request may be queued or polled until a pod is available to serve the request.

At S420, it is checked if an instance of the pod containing code for executing the requested function is available and, if so, execution continues with S440; otherwise, execution continues with S430. In an embodiment, a pod is available if there are no connections to the pod for providing its function.

At S430, when it is determined that there is not an available pod for the requested function, a new instance of the pod is instantiated. The new instance of the pod is a copy of an original pod such that there is (at least initially) no difference between pods for the same function. In an embodiment, S430 also includes mapping the new instance of the pod to a shared memory for identical instances of the pod.

At S440, a connection to an available pod is established and the function is invoked, and execution continues with S410 when another event is received.

FIG. 5 is an example block diagram of a hardware layer 500 include in each node according to an embodiment. That is, each of the master node, operational node, and worker node is independently executed over a hardware layer, such as the layer shown in FIG. 5.

The hardware layer 500 includes a processing circuitry 510 coupled to a memory 520, a storage 530, and a network interface 540. In another embodiment, the components of the hardware layer 500 may be communicatively connected via a bus 550.

The processing circuitry 510 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 520 may be volatile (e.g., RAM, etc.), non-volatile (e.g., ROM, flash memory, etc.), or a combination thereof. In one configuration, computer readable instructions to implement one or more embodiments disclosed herein may be stored in the storage 530.

In another embodiment, the memory 520 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 510, configure the processing circuitry 510 to perform the various processes described herein.

The storage 530 may be magnetic storage, optical storage, and the like, and may be realized, for example, as flash memory or other memory technology, CD-ROM, Digital Versatile Disks (DVDs), or any other medium which can be used to store the desired information.

The network interface 540 allows the hardware layer 500 to communicate over one or more networks, for example, to receive requests for functions from user devices (not shown) for distribution to the pods and so on.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A scalable platform for providing functions as a service (FaaS), comprising:
at least one master node executed over a hardware layer;
a plurality of worker nodes communicatively connected to the at least one master node and independently executed over a hardware layer;
wherein each of the plurality of worker nodes includes at least one pod, wherein each pod is a software container including code for executing a respective serverless function; and
wherein the at least one pod of each of the plurality of operational nodes is scalable on demand by the at least one master node.

2. The scalable platform of claim 1, further comprising:
at least one operational node communicatively connected to at least one master node and to the plurality of worker nodes, wherein the at least one operational node is independently executed over a hardware layer.

3. The scalable platform of claim 2, wherein the at least operational node further comprises:
at least one poller configured to delay provisioning of polled events indicating requests for executing serverless functions from a cloud service, wherein the cloud service is any one of: a database and a stream service.

4. The scalable platform of claim 3, wherein the at least one poller is further configured to:
perform a time loop;
periodically check for an external host for changes in a state for the cloud service; and
invoke the function on respective pod when a change in the state has occurred.

5. The scalable platform of claim 1, wherein the least one master node further comprises:
a master load balancer configured to receive requests to serverless functions by the pods of the plurality of worker nodes and balance the load among the various pods;
a scheduler configured to schedule activation of the pods of the plurality of worker nodes based on demand;
a queue configured to queue requests to execute serverless functions; and
an autoscaler configured to receive events indicating pending requests and to scale the pods of the plurality of worker nodes according to a current demand.

6. The scalable platform of claim 5, wherein the master load balancer is further configured to:
check if there is a pod on one of the worker nodes available for executing the serverless function, wherein a pod is available for executing the serverless function when there are no active connections; and
request the autoscaler to determine a number of pods required to execute the requested serverless function when no pods are available for executing the serverless function.

7. The scalable platform of claim 6, wherein the scheduler is further configured to:
receive, from the autoscaler, a number of pods to be activated, wherein the number of pods to be activated is at least one;
instantiate at least one new pod configured to execute the requested serverless function, wherein each of the at least one new pod is a copy of an original pod of the pods of the plurality of worker nodes, wherein instantiation of the at least one new pod includes mapping the t least one new pod to a shared physical memory utilized by the original pod;
establish a new connection to the at least one new pod.

8. The scalable platform of claim 7, wherein the master load balancer is further configured to:
receive an internet protocol (IP) of the newly activated pod; and
invoke the serverless function on the newly activated pod.

9. The scalable platform of claim 1, wherein each of the plurality of worker nodes further includes a worker load balancer configured to balance requests among the at least one pod of the worker node.

10. The scalable platform of claim 9, wherein the master load balancer is further configured to:
select one worker node of the plurality of worker nodes, wherein the selection is based on a load of each of the plurality of worker nodes; and
send a request to run a serverless function to the selected worker node over a port number associated with the serverless function, wherein the selected worker node activates a first pod of the at least one pod of the selected worker node based on the port number using its respective master load balancer.

11. The scalable platform of claim 9, wherein the master load balancer is further configured to:
send a request to execute a serverless function to the plurality of worker nodes;
receive, from each of the plurality of worker nodes, a score indicating its ability to run the requested serverless function; and
select an operational node to run the requested serverless function based on the received scores.

12. The scalable platform of claim 11, wherein the request to execute the serverless function sent to the plurality of worker nodes is received from external cloud computing services.

13. The scalable platform of claim 1, wherein each of the plurality of worker nodes is executed over a different cloud computing platform.

14. The scalable platform of claim 2, wherein the hardware layer includes:
a processing circuitry;
a memory containing instructions to be executed by the processing circuitry; and
a network interface.

15. A method for migrating serverless functions from a first functions as a service (FaaS) platform to a second FaaS platform, comprising:
obtaining code and configurations of a plurality of serverless functions from the first FaaS platform;
updating an infrastructure of the second FaaS platform by deploying software images of the plurality of serverless functions, wherein the second FaaS platform is a scalable FaaS platform;
obtaining, from the first FaaS platform, a current load for each of the plurality of serverless functions; and
scaling the second FaaS platform based on the obtained current loads.

16. The method of claim 15, wherein the code and configurations of the plurality of serverless functions are retrieved from software containers configured to execute the plurality of serverless functions in the first FaaS platform.

17. The method of claim 15, wherein the second FaaS platform further includes:
at least one master node executed over a hardware layer;
a plurality of worker nodes communicatively connected to the at least one master node and independently executed over a hardware layer;
wherein each of the plurality of worker nodes includes at least one pod, wherein each pod is a software container including code for executing a respective serverless function; and
wherein pods at each of the plurality of operational nodes are scalable on demand by the at least one master node.

18. The method of claim 17, wherein the second FaaS platform further includes:
at least one operational node communicatively connected to the at least one master node and to the plurality of worker nodes, wherein the at least one operational node is independently executed over a hardware layer.

19. A non-transitory computer readable medium having stored thereon instructions for causing processing circuity circuitry to perform a process for migrating serverless functions from a first functions as a service (FaaS) platform to a second FaaS platform, the process comprising:
at least one master node executed over a hardware layer;
a plurality of worker nodes communicatively connected to the at least one master node and independently executed over a hardware layer;
wherein each of the plurality of worker nodes includes at least one pod, wherein each pod is a software container including code for executing a respective serverless function; and
wherein the at least one pod of each of the plurality of operational nodes is scalable on demand by the at least one master node.
